(19) United States
(12) Patent Application Publication
(10) Pub. No.: US 2018/0099637 A1
(43) Pub. Date: Apr. 12, 2018

(54) DUAL-STAGE CUSHION FLAPS AND RELATED SYSTEMS AND METHODS

(71) Applicant: Autoliv ASP, Inc., Ogden, UT (US)

(72) Inventors: ChangSoo Choi, Rochester, MI (US); David Keyser, Orion, MI (US)

(21) Appl. No.: 15/288,944

(22) Filed: Oct. 7, 2016

(51) Int. Cl. B60R 21/237; B60R 21/2165; B60R 21/205; B60R 21/2342

(52) U.S. Cl. CPC B60R 21/237; B60R 21/2165; B60R 2021/0048; B60R 21/2342; B60R 21/205

(57) ABSTRACT

Airbag cushion assemblies comprising airbag cushion flaps for safety. In some embodiments, the assembly may comprise an airbag housing and an airbag cushion positioned within the airbag housing. An airbag cushion flap may extend from the airbag cushion and may be configured to allow the airbag cushion to deploy from the airbag housing in at least two stages, wherein, in a first stage of the at least two stages, the airbag cushion flap is configured to expand to allow the airbag cushion to partially deploy and wherein, in a second stage of the at least two stages, the airbag cushion is configured to contact the airbag cushion flap and to reduce a punch-out force delivered by the airbag cushion during deployment by, for example, extending through the airbag cushion flap.

### SUMMARY

Many current airbag assemblies require specially-tuned inflators to deal with low risk deployment (LRD) and/or out-of-position (OOP) requirements in order to reduce vehicle occupant injuries. Alternatively, safety vents may be used for this purpose. However, both of these solutions are often very costly and may not be ideal for providing other desired deployment kinematic characteristics.

The present inventors have therefore determined that it would be desirable to provide systems and methods that overcome one or more of the foregoing limitations and/or other limitations of the prior art. In some embodiments, the inventive concepts disclosed herein may improve various safety functions of airbag systems, such as, for example, by reducing punch-out force, reducing OOP injuries, or otherwise generally reducing the likelihood and/or severity of occupant injury. This may be accomplished, in some embodiments disclosed herein, by providing an airbag cushion that is coupled with an airbag cushion flap. This flap may, in some embodiments, be partially wrapped around and at least partially folded above or laterally with respect to an inflatable portion of the airbag cushion. The flap may further comprise a weakened portion, such as a tear seam, positioned such that the inflating cushion contacts the weakened portion, after unfolding the folded portion, and extends through the flap. In some embodiments, a portion of the flap may serve as a friction flap to further direct deployment kinematics as desired.

In a more particular example of an airbag cushion assembly according to some embodiments, the assembly may comprise an airbag housing and an airbag cushion positioned within the airbag housing. The airbag cushion may comprise an airbag cushion flap extending from the airbag cushion. In some embodiments, the flap may extend from the cushion as an integral part of the cushion. The airbag cushion flap may be configured to allow the airbag cushion to deploy from the airbag housing in at least two stages, wherein, in a first stage of the at least two stages, the airbag cushion flap is configured to expand to allow the airbag cushion to partially deploy, and wherein, in a second stage of the at least two stages, the airbag cushion is configured to contact the airbag cushion flap and to reduce a punch-out force delivered by the airbag cushion during deployment.

In some embodiments, the airbag cushion flap may comprise a weakened portion, such as a tear seam, configured to sever during deployment of the airbag cushion. In some such embodiments, the airbag cushion may be configured such that the weakened portion severs after the first stage, and such that the weakened portion is positioned in a direction of deployment of the airbag cushion such that the airbag cushion contacts and severs the weakened portion during deployment.

In some embodiments, the airbag cushion flap may further comprise a folded portion comprising a plurality of layers of the airbag cushion flap. In some such embodiments, the airbag cushion comprises a tear stitch configured to hold the folded portion in place prior to deployment of the airbag cushion.

In some embodiments, the weakened portion is positioned in at least one of the layers of the folded portion. In some such embodiments, the weakened portion is positioned underneath a top layer of the folded portion.

In some embodiments, the folded portion is positioned above the airbag cushion within the airbag housing, and the airbag cushion is configured to hold the folded portion in place prior to deployment of the airbag cushion, such as by providing a tear stitch in the folded portion. Alternatively, the folded portion may be positioned laterally of the airbag cushion, yet preferably still adjacent to an upper end of the airbag housing. Preferably, the folded portion is configured to unfold during deployment of the inflatable portion to define an expanded region of the airbag cushion flap during the first stage.

In some embodiments, the airbag cushion flap is configured to increase lateral expansion of the airbag cushion during the first stage of deployment of the airbag cushion.

In an example of an airbag cushion assembly according to other embodiments, the assembly may comprise an airbag housing and an airbag cushion positioned within the airbag housing. The airbag cushion may comprise an inflatable portion and an extended flap portion coupled with the inflatable portion. In some embodiments, the extended flap portion may be integrally coupled with the inflatable portion. The extended flap portion may be at least partially wrapped around the inflatable portion of the airbag cushion within the airbag housing. In some embodiments, the extended flap portion may be partially wrapped around the inflatable portion such that the inflatable portion can expand out of two opposite sides of the extended flap portion.

At least a portion of the extended flap portion may be configured to allow the inflatable portion of the airbag cushion to partially expand into an expanded portion of the extended flap portion. The extended flap portion may comprise a weakened portion, such as a tear seam, configured to sever during deployment of the inflatable portion of the airbag cushion after the inflatable portion of the airbag cushion has inflated into the expanded portion. The extended flap portion may be further configured such that the weakened portion is configured and positioned so as to be positioned in a direction of deployment of the inflatable portion such that the inflatable portion contacts and severs the weakened portion during deployment.

In some embodiments, the extended flap portion is configured to allow the airbag cushion to deploy from the airbag housing in at least two stages, wherein, in a first stage of the at least two stages, the extended flap portion is configured to expand to allow the inflatable portion of the airbag cushion to partially deploy, and wherein, in a second stage of the at least two stages, the airbag cushion is configured to contact the extended flap portion and to reduce a punch-out force delivered by the airbag cushion during deployment prior to severing the weakened portion.

In some embodiments, the extended flap portion comprises a folded portion comprising a plurality of layers of the extended flap portion such that the inflatable portion of the airbag cushion can partially expand into the expanded portion after the folded portion has unfolded to define the expanded portion. In some such embodiments, the folded portion is defined by an accordion fold.

In some embodiments, the weakened portion is formed in at least one of the layers of the folded portion. In some such embodiments, the weakened portion is positioned underneath a top layer of the folded portion.

In an example of an airbag cushion assembly according to still another embodiment, the assembly may comprise an airbag housing comprising a bottom end and a top end opposite from the bottom end. An airbag cushion may be positioned within the airbag housing and configured to deploy from the top end of the airbag housing. The airbag cushion may comprise an inflatable portion and an extended flap portion extending from the inflatable portion, preferably as an integral part of the inflatable portion. The extended flap portion may be at least partially wrapped around the inflatable portion within the airbag housing prior to deployment. The extended flap portion may comprise a folded portion comprising a plurality of layers of the extended flap portion. The folded portion is preferably positioned either above or laterally of the inflatable portion adjacent to the top end of the airbag housing and preferably comprises a tear stitch or another suitable means configured to hold the folded portion in place prior to deployment of the airbag cushion. The folded portion may be configured to unfold during deployment of the inflatable portion to define an expanded region of the extended flap portion.

A tear seam may be formed in at least one of the layers of the folded portion, wherein the tear seam is configured to sever during deployment of the inflatable portion of the airbag cushion by contact with the inflatable portion after the inflatable portion has broken the tear stitch and the folded portion has unfolded to define the expanded region.

In some embodiments, the tear seam is positioned underneath a top layer of the folded portion.

In some embodiments, the extended flap portion is configured to redirect inflation of the airbag cushion during deployment to reduce injuries to an out-of-position vehicle occupant.

The features, structures, steps, or characteristics disclosed herein in connection with one embodiment may be combined in any suitable manner in one or more alternative embodiments.

### BRIEF DESCRIPTION OF THE DRAWINGS

Non-limiting and non-exhaustive embodiments of the disclosure are described, including various embodiments of the disclosure with reference to the figures, in which:

FIG. 1 depicts an airbag cushion comprising an airbag cushion flap according to one embodiment, shown in an unfolded configuration;

FIG. 2 depicts the airbag cushion of FIG. 1 after folding a portion of the airbag cushion flap to form a folded portion;

FIG. 3 is a cross-sectional view of an airbag cushion assembly according to another embodiment;

FIG. 4 is a cross-sectional view of the airbag cushion assembly of FIG. 3 following an initial stage of deployment;

FIG. 5 is a perspective view of the airbag cushion assembly of FIG. 3 following an initial stage of deployment;

FIG. 6 is a cross-sectional view of the airbag cushion assembly of FIG. 3 after an inflatable portion of the cushion has extended through the airbag cushion flap;

FIG. 7 is a perspective view of the airbag cushion of the airbag cushion assembly of FIG. 3;

FIG. 8 is a schematic diagram of an airbag cushion assembly according to still another embodiment; and

FIG. 9 is a schematic diagram of the airbag cushion assembly of FIG. 8 following an initial stage of deployment.

### DETAILED DESCRIPTION

A detailed description of apparatus, systems, and methods consistent with various embodiments of the present disclosure is provided below. While several embodiments are described, it should be understood that the disclosure is not limited to any of the specific embodiments disclosed, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

Apparatus, methods, and systems are disclosed herein relating to airbag cushion assemblies comprising airbag cushion flaps configured to allow for control of airbag cushion deployment to improve safety. In preferred embodiments, the airbag cushion flaps are partially wrapped around an inflatable portion of the cushion prior to deployment and include a layered and/or folded region positioned above or laterally of the cushion. Upon deployment, the inflatable portion may unfold and/or expand this region to define an expanded region. Subsequently, the inflatable portion may contact a weakened portion of the flap such that the inflatable portion extends through the flap.

The embodiments of the disclosure may be best understood by reference to the drawings, wherein like parts may be designated by like numerals. It will be readily understood that the components of the disclosed embodiments, as generally described and illustrated in the figures herein, could be arranged and designed in a wide variety of different configurations. Thus, the following detailed description of the embodiments of the apparatus and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified. Additional details regarding certain preferred embodiments and implementations will now be described in greater detail with reference to the accompanying drawings.

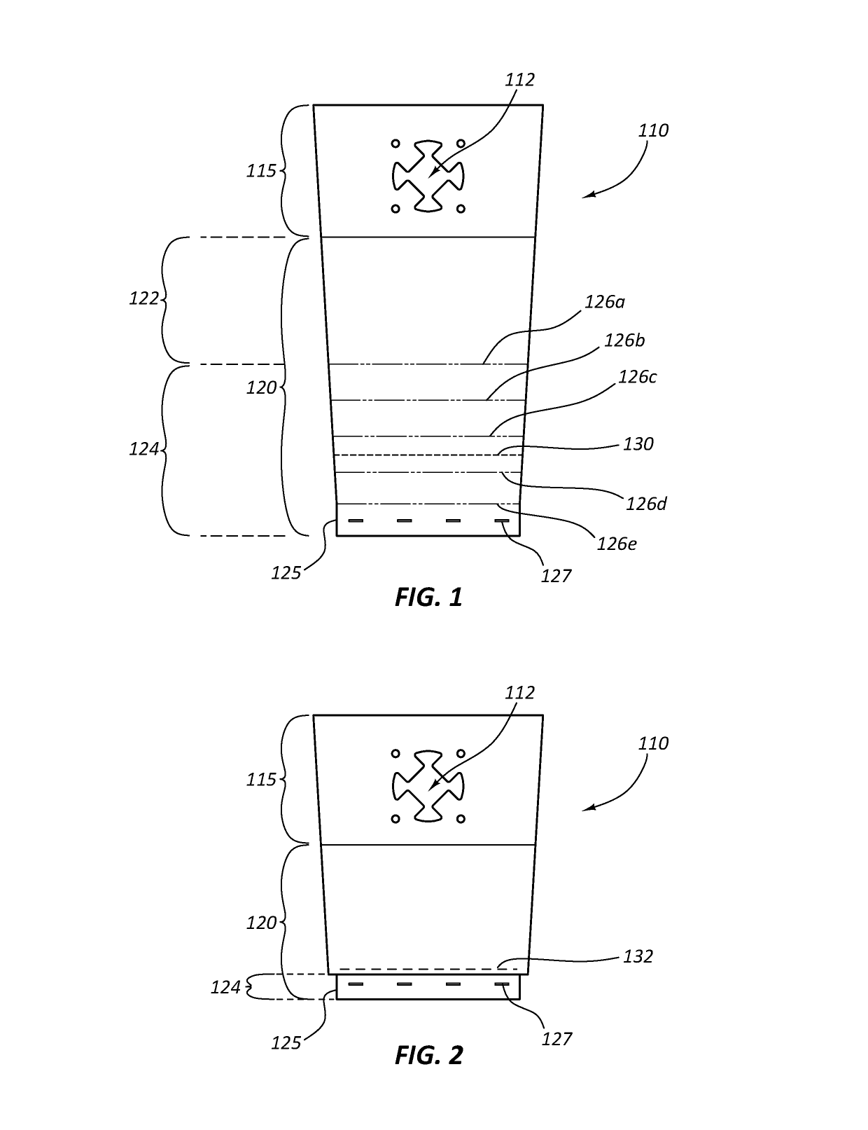

FIG. 1 depicts an airbag cushion 110 for use in connection with certain airbag cushion assemblies disclosed herein. Airbag cushion 110 comprises an inflator opening 112 configured to receive an inflator (not shown) therein. Airbag cushion 110 further comprises an inflatable portion 115 and an extended flap portion 120 extending from the inflatable portion 115. In the depicted embodiment, extended flap portion 120 extends from inflatable portion 115 as an integral part of the inflatable portion 115. However, alternative embodiments are contemplated in which flap portion 120 may be attached to, rather than integrally part of (i.e., made from the same material) inflatable portion 115. Preferably, extended flap portion 120 comprises a single layer, although alternative embodiments are contemplated in which extended flap portion 120 may comprise multiple layers.

In the depicted embodiment, extended flap portion 120 comprises two subsections, namely, a wrapper portion 122 and a folded portion 124. Wrapper portion 122 is configured to be at least partially wrapped around the inflatable portion 115 of airbag cushion 110 within an airbag housing (not shown in FIG. 1). Folded portion 124 comprises a plurality of folds, namely folds 126a-126e, which are configured to be layered together and, as will be more apparent in connection with later figures, are preferably positioned either above or laterally of the inflatable portion 115 adjacent to a top end of an airbag housing prior to deployment. In some embodiments and implementations, folded portion 124 is defined by an accordion fold.

Extended flap portion 120 of airbag cushion 110 further comprises a coupling tab 125 comprising one or more slots 127 for receiving hooks or other similar features of an airbag housing, again, as will be shown in connection with later figures and described below. In addition, extended flap portion 120 further comprises a weakened portion 130 that is configured to sever during deployment of airbag cushion 110. In preferred embodiments, weakened portion 130 comprises a tear seam. Preferably, weakened portion 130 is positioned within folded portion 124 of extended flap portion 120, for reasons discussed below. However, alternative embodiments are contemplated in which weakened portion 130 may instead be positioned within wrapper portion 122.

FIG. 2 depicts airbag cushion 110 after extended flap portion 120 has been folded. In addition, in preferred embodiments and implementations, the folds of folded portion 124 are held in place by way of means for releasably holding one or more folds, such as a tear stitch 132, for example. Tear stitch 132 is configured to hold folded portion 124 in place prior to deployment of airbag cushion 110. During inflation of airbag cushion 110, the inflatable portion 115 of airbag cushion 110 is configured to break tear stitch 132 to allow folded portion 124 to unfold during deployment to define an expanded region of the extended flap portion 120.

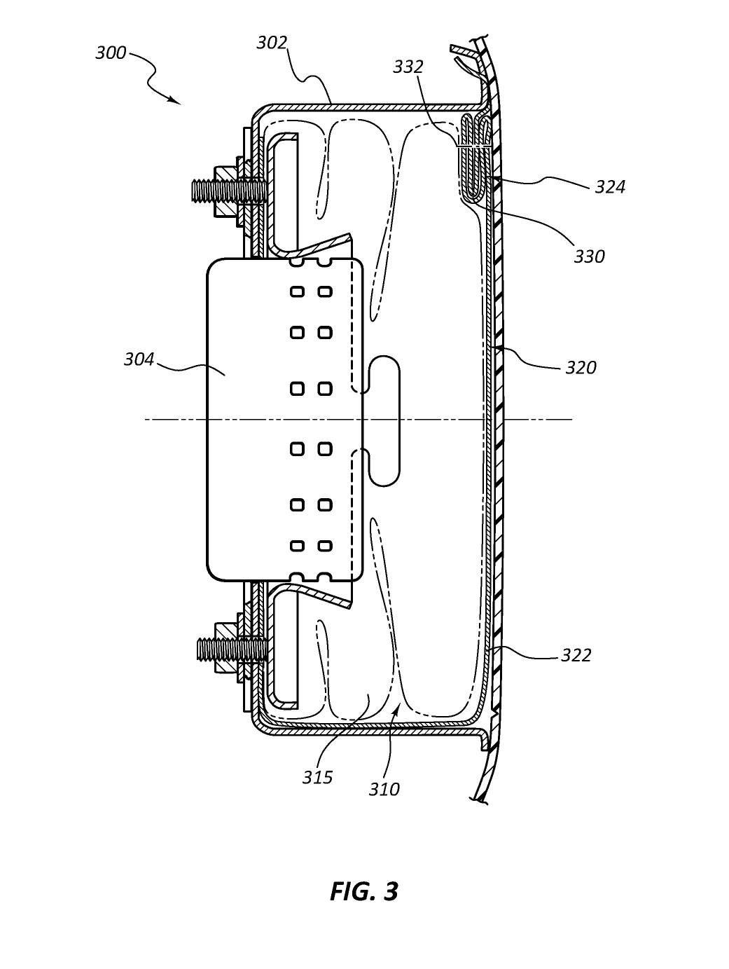

FIG. 3 is a cross-sectional view of an airbag assembly 300 according to some embodiments. Airbag assembly 300 comprises an airbag housing 302, an inflator 304, and an airbag cushion 310 positioned within the airbag housing 302 and positioned and configured to receive inflation gas from inflator 304. Airbag cushion 310 comprises an inflatable portion 315 and an extended flap portion 320 extending from the inflatable portion 315. As previously mentioned, extended flap portion 320 preferably extends from inflatable portion 315 as an integral part of the inflatable portion 315 but may, in alternative embodiments, be separately coupled to inflatable portion 315.

Extended flap portion 320 again comprises a wrapper portion 322, which is positioned above the inflatable portion 315 of airbag cushion 310 adjacent to an upper end of airbag housing 302 from which airbag cushion 310 is configured to be deployed, and a folded portion 324 comprising a plurality of layers of extended flap portion 320. Folded portion 324 is held in place with a tear stitch 332 and wrapper portion 322 is wrapped around at least a portion of the inflatable portion 315 of airbag cushion 310.

In addition, a weakened portion 330 is formed within along at least part of extended flap portion 320. Weakened portion 330 may comprise, for example, a tear seam, which may comprise a plurality of aligned slits formed within extended flap portion 320. In the embodiment depicted in FIG. 3, weakened portion 330 is positioned in one of the layers of folded portion 324. More particularly, in this particular embodiment, weakened portion 330 is positioned underneath a top layer of the folded portion 324. This may be preferable to protect the weakened portion 330 by reducing exposure to various external elements during assembly and thereby reduce the possibility of inadvertent breaking/tearing of weakened portion 330 during assembly or otherwise prior to deployment.

Extended flap portion 320 is configured to allow the airbag cushion 310 to deploy from the airbag housing 302 in at least two stages. More particularly, in a first stage of the at least two stages, the inflatable portion 315 of airbag cushion 310 is configured to break tear stitch 332, thereby allowing extended flap portion 320 to expand (by unfolding of folded portion 324) and allow the airbag cushion 310 to partially deploy into an expanded region defined at least in part by unfolding of folded portion 324.

In a second stage of the at least two stages, the inflatable portion 315 of airbag cushion 310 is configured to contact the unfolded region of extended flap portion 320 and reduce a punch-out force delivered by the airbag cushion 310 during deployment by contacting weakened portion 330 prior to expanding further into an occupant region of a vehicle.

Although FIG. 3 depicts folded portion 324 as being positioned on top of the inflatable portion 315 of airbag cushion 310, alternative embodiments are contemplated in which folded portion 324 is positioned laterally of inflatable portion 315 within housing 302. This may be preferred for certain applications, since it reduces the space occupied by the extended flap portion 320 in a direction towards the instrument panel (for embodiments configured for use as passenger-side airbags).

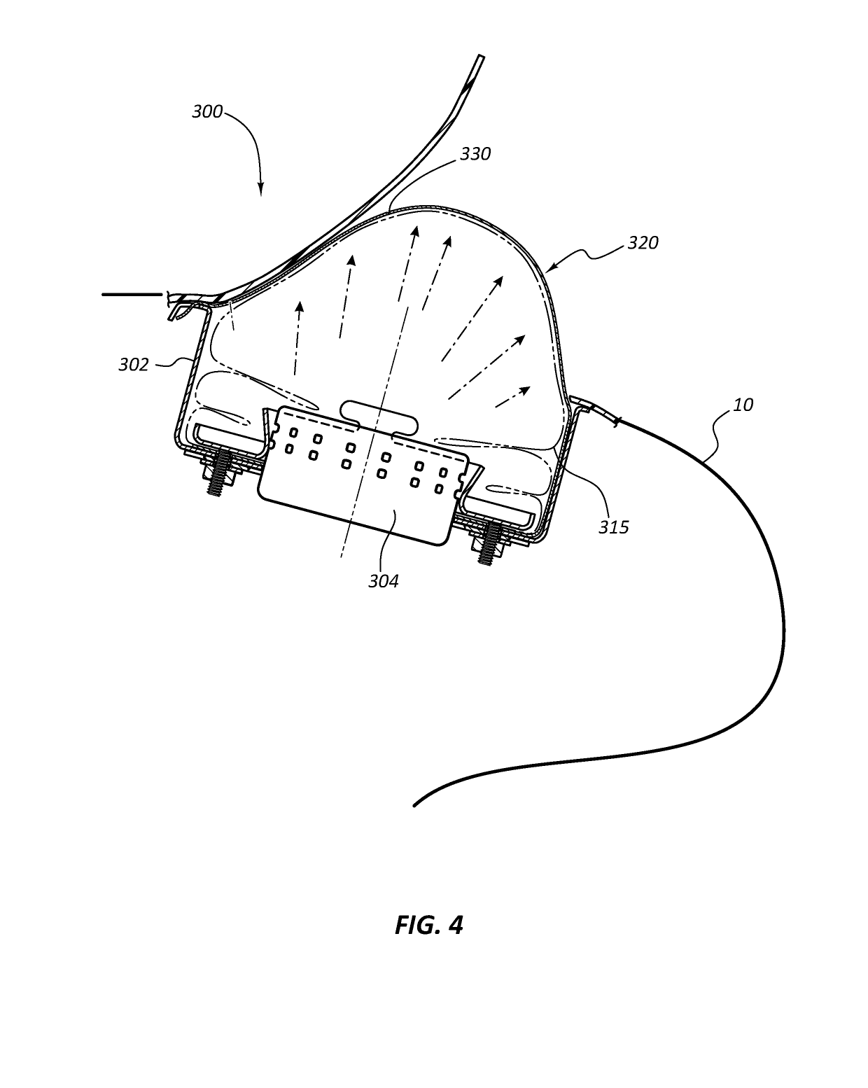

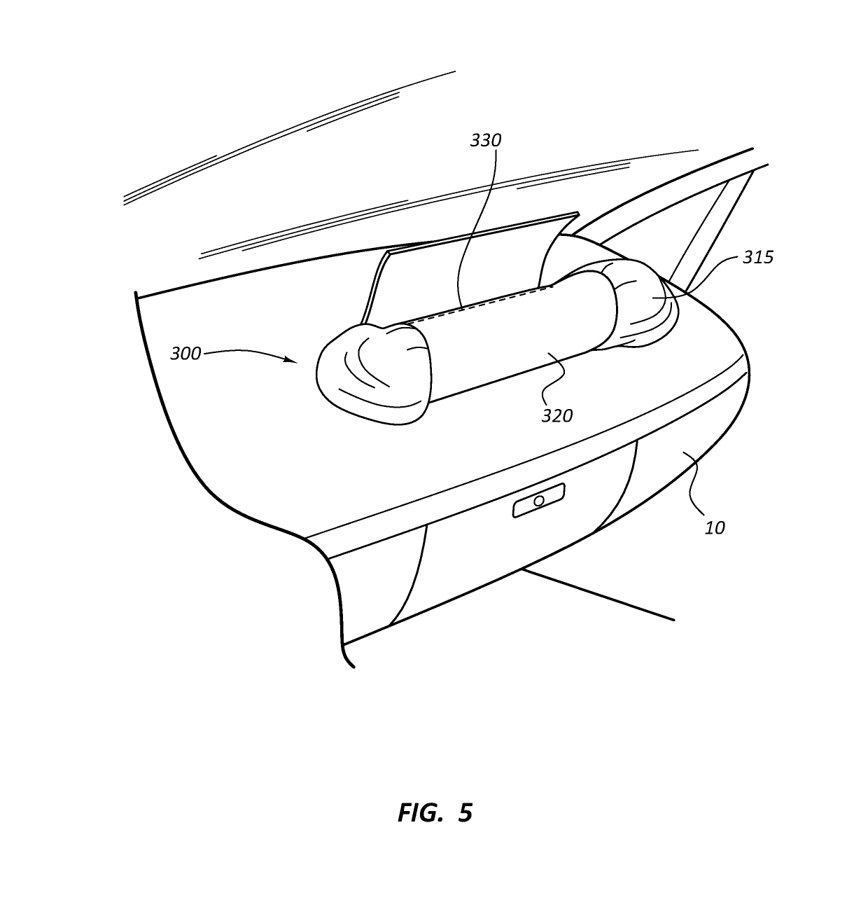

FIGS. 4 and 5 depict airbag assembly 300 during deployment from within an instrument panel 10 of a vehicle after tear stitch 332 has been broken, but before weakened portion 330 has been broken. More particularly, FIG. 4 is a cross-sectional view of airbag assembly 300 in this particular stage of inflation and FIG. 5 is a perspective view of airbag assembly in this same stage. Although airbag assembly 300 may be particularly suitable for use as a passenger airbag, it should be understood that one or more of the inventive principles disclosed herein may be applicable to other airbags, such as driver airbags, in alternative embodiments.

As best shown in FIG. 5, extended flap portion 320 is configured to increase lateral expansion of airbag cushion 310 during the first stage of deployment (i.e., prior to severing of weakened portion 330. This may be accomplished by only wrapping a portion, such as a strip, of extended flap portion 320 around the inflatable portion 315 of airbag cushion 310, such that the cushion 310 may expand laterally in two directions, as depicted in FIG. 5, and by virtue of providing a tear seam or another similar weakened portion. This may allow for slowing of cushion expansion towards the occupant in favor of lateral expansion, which may reduce punch-out force and/or provide increased surface area to contact an OOP occupant, thereby reducing the likelihood and/or severity of possible OOP injuries.

As also best shown in FIG. 5, in preferred embodiments, extended flap portion 320 may be wrapped only partially around the inflatable portion 315 of airbag cushion 310, rather than fully encapsulating the inflatable portion 315. This may be beneficial for several reasons. First, this may decrease fabric and accompanying costs. Second, this may reduce the complexity of assembly and save space. And third, this may be useful in allowing one or more regions of the inflatable portion 315 of the cushion to expand in selected ways and/or directions prior to breaking the weakened portion 330, as discussed above.

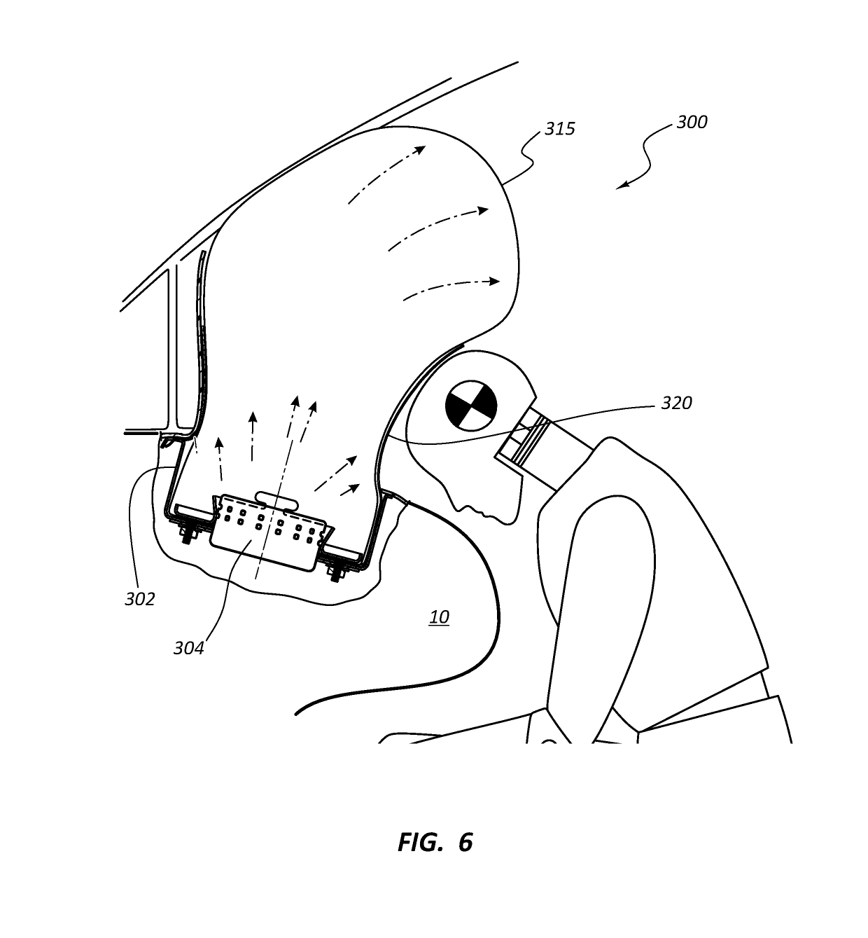

FIG. 6 is a cross-sectional view of airbag assembly 300 following full inflation/deployment. As depicted in this figure, after severing weakened portion 330, the inflatable portion 315 of airbag cushion 310 is free to expand towards the occupant, rather than only laterally as in the previous stage discussed above.

In addition, in some embodiments, extended flap portion 320 may continue to serve a purpose following severing of weakened portion 330. To explain, during inflation after severing of weakened portion 330, extended flap portion 320 may be configured to serve as an OOP flap or a “friction flap.” The OOP/friction flap may be used in certain OOP positions to direct the cushion over the head of the OOP occupant and/or prevent the expanding cushion 310 from going into the neck (under the chin) of an occupant. Thus, in some such embodiments, it may be desirable to position the weakened portion 320 at a location that allows for the resulting flap (defined by the proximal (relative to the occupant) portion of extended flap portion 320 relative to weakened portion 330) to be of a sufficient length to maintain contact with airbag cushion 310 and continue to direct inflation in a desired manner. In addition, as discussed below in connection with FIG. 9, the precise location of the weakened portion may be altered in accordance with the desired deployment characteristics as needed to tune inflation dynamics.

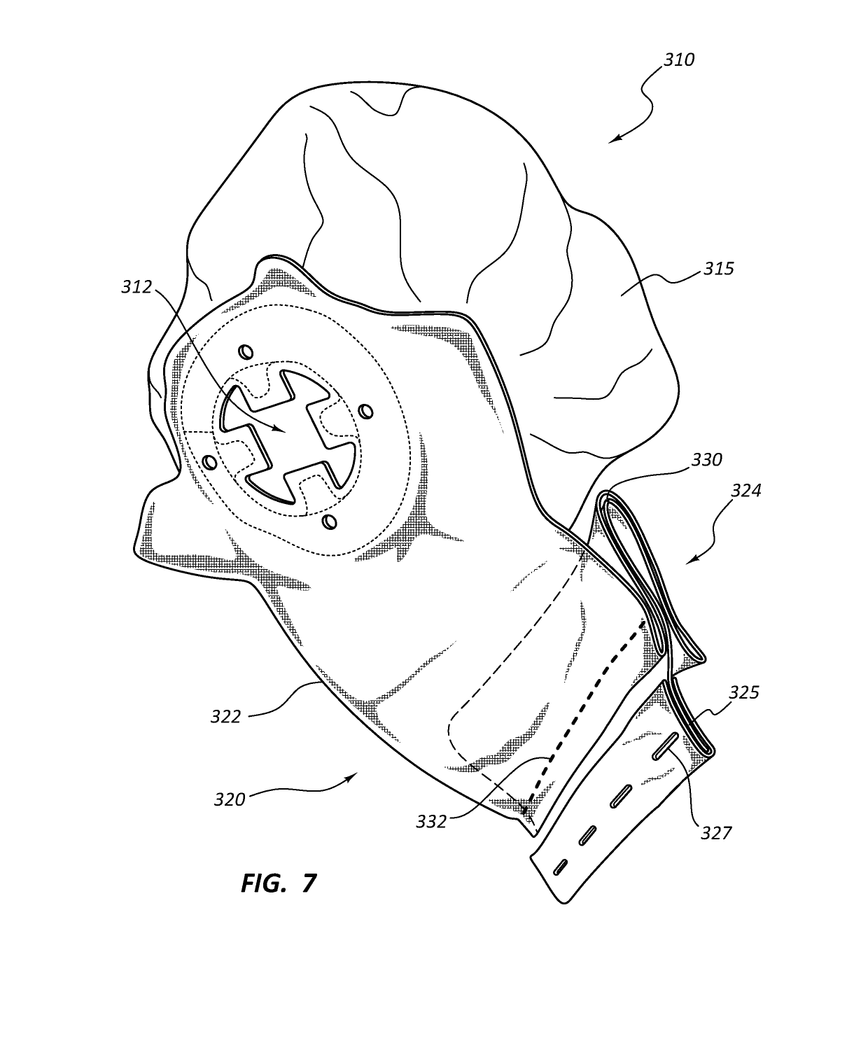

FIG. 7 is a perspective view of airbag cushion 310 removed from airbag housing 302 but in an otherwise fully assembled configuration. As better illustrated in this figure, extended flap portion 320 extends from a base of inflatable portion 315 adjacent to inflator opening 312. In addition, the preferred location of weakened portion 330 can be seen in this figure, which, as previously mentioned, is within folded portion 324 and, more preferably, within an inner layer of folded portion 324 so as to avoid direct contact with a door or other items immediately adjacent to a top or upper region of the airbag housing. In addition, this figure illustrates that, like airbag cushion 110, airbag cushion 310 comprises a coupling tab 325 comprising one or more slots 327 to facilitate a secure connection with one or more hooks or other coupling features on the airbag housing. In addition, FIG. 7 illustrates that coupling tab 325 may comprise a plurality of layers, one of which may comprise a layer defining the remainder of extended flap portion 320 (i.e., wrapper portion 322 and folded portion 324) to reinforce the strength of this region of airbag cushion 310 if desired.

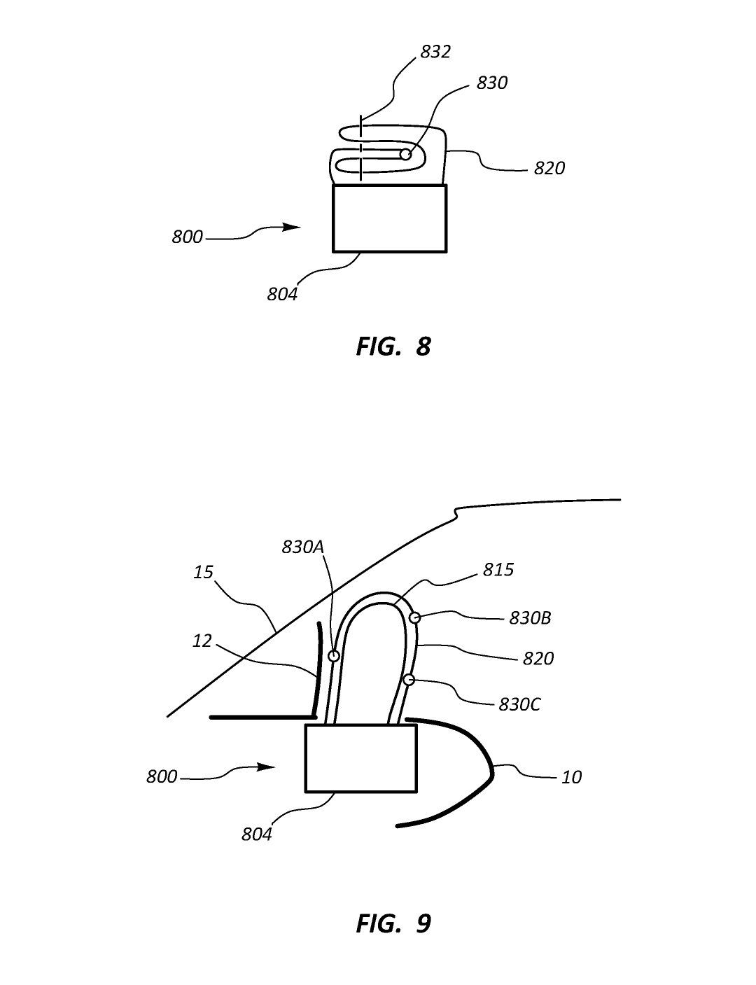

FIGS. 8 and 9 are schematic representations of another embodiment of an airbag assembly 800 to illustrate the possibility for tuning deployment characteristics of an airbag cushion contained therein by altering the position of the weakened portion 830 relative to other elements of the assembly 800. More particularly, airbag assembly 800 may comprise an airbag cushion positioned within airbag housing 804 and comprising an inflatable portion 815 and an airbag cushion flap 820. Flap 820, as previously mentioned, may comprise an integral part of the cushion itself or, alternatively, may be made up of a different material and/or separately coupled with the inflatable portion 815 of the cushion. As also previously mentioned, a tear stitch 832 or another similar means for releasably holding one or more folds of an airbag cushion flap may be used to maintain a folded/layered portion of flap 820 in a position either above or laterally of the inflatable portion 815 (not visible in FIG. 8). A tear line or another similar weakened portion 830 may be positioned along flap 820. Preferably, weakened portion 830 is positioned along one or more of the folds of the folded region, and even more preferably, below an upper surface of the folded region to reduce exposure, as previously mentioned.

Following an initial stage of deployment in which inflatable portion 815 breaks tear stitch 832, the airbag cushion may be in a configuration as generally shown in FIG. 9, which adds further context by providing a vehicle windshield 15 and door 12, such as an instrument panel door of an instrument panel 10 from which the airbag cushion deploys. FIG. 9 also illustrates three possible alternative locations for the weakened portion 830, which corresponds with the breakaway location through which the inflatable portion 815 will extend through flap 820. Location 830A may be preferable for creating a large OOP/friction flap, which may further guide deployment of the airbag cushion by, for example, directing the cushion over the head of the OOP occupant and/or prevent the expanding cushion 815 from going into the neck (under the chin) of an occupant. Location 830C may provide less surface area for creation of a friction flap, but may still assist in reducing punch-out forces and/or increasing lateral surface area of the inflating airbag to assist in OOP protection. Location 830C may also be useful for reducing cushion loading onto windshield 17. And location 830B may be an intermediate position that combines some of the benefits of the other two positions. By changing the position of the breakaway location, the cushion deployment kinematics may be tuned in accordance with, for example, the type of instrument panel, type and position of airbag, other vehicle particularities, etc.

The foregoing specification has been described with reference to various embodiments and implementations. However, one of ordinary skill in the art will appreciate that various modifications and changes can be made without departing from the scope of the present disclosure. For example, various operational steps, as well as components for carrying out operational steps, may be implemented in various ways depending upon the particular application or in consideration of any number of cost functions associated with the operation of the system. Accordingly, any one or more of the steps may be deleted, modified, or combined with other steps. Further, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced, are not to be construed as a critical, a required, or an essential feature or element.

Those having skill in the art will appreciate that many changes may be made to the details of the above-described embodiments without departing from the underlying principles of the invention. The scope of the present inventions should, therefore, be determined only by the following claims.

1. An airbag cushion assembly, comprising:
an airbag housing; and
an airbag cushion positioned within the airbag housing; and
an airbag cushion flap extending from the airbag cushion as an integral part of the airbag cushion, wherein the airbag cushion flap is configured to allow the airbag cushion to deploy from the airbag housing in at least two stages, wherein, in a first stage of the at least two stages, the airbag cushion flap is configured to expand to allow the airbag cushion to partially deploy, and wherein, in a second stage of the at least two stages, the airbag cushion is configured to contact the airbag cushion flap and to reduce a punch-out force delivered by the airbag cushion during deployment.

2. The airbag cushion assembly of claim 1, wherein the airbag cushion flap comprises a weakened portion configured to sever during deployment of the airbag cushion.

3. The airbag cushion assembly of claim 2, wherein the weakened portion comprises a tear seam.

4. The airbag cushion assembly of claim 2, wherein the airbag cushion is configured such that the weakened portion severs after the first stage, and wherein the airbag cushion is configured such that the weakened portion is positioned in a direction of deployment of the airbag cushion such that the airbag cushion contacts and severs the weakened portion during deployment.

5. The airbag cushion assembly of claim 2, wherein the airbag cushion flap further comprises a folded portion comprising a plurality of layers of the airbag cushion flap.

6. The airbag cushion assembly of claim 5, wherein the folded portion is positioned above the airbag cushion within the airbag housing, wherein the airbag cushion is configured to hold the folded portion in place prior to deployment of the airbag cushion, and wherein the folded portion is configured to unfold during deployment of the inflatable portion to define an expanded region of the airbag cushion flap during the first stage.

7. The airbag cushion assembly of claim 6, wherein the airbag cushion comprises a tear stitch configured to hold the folded portion in place prior to deployment of the airbag cushion.

8. The airbag cushion assembly of claim 7, wherein the weakened portion is positioned in at least one of the layers of the folded portion.

9. The airbag cushion assembly of claim 8, wherein the weakened portion is positioned underneath a top layer of the folded portion.

10. The airbag cushion assembly of claim 1, wherein the airbag cushion flap is configured to increase lateral expansion of the airbag cushion during the first stage of deployment of the airbag cushion.

11. An airbag cushion assembly, comprising:
an airbag housing; and
an airbag cushion positioned within the airbag housing, wherein the airbag cushion comprises:
an inflatable portion; and
an extended flap portion coupled with the inflatable portion, wherein the extended flap portion is at least partially wrapped around the inflatable portion of the airbag cushion within the airbag housing, wherein at least a portion of the extended flap portion is configured to allow the inflatable portion of the airbag cushion to partially expand into an expanded portion of the extended flap portion, wherein the extended flap portion comprises a weakened portion configured to sever during deployment of the inflatable portion of the airbag cushion after the inflatable portion of the airbag cushion has inflated into the expanded portion, and wherein the extended flap portion is configured such that the weakened portion is configured and positioned so as to be positioned in a direction of deployment of the inflatable portion such that the inflatable portion contacts and severs the weakened portion during deployment.

12. The airbag cushion assembly of claim 11, wherein the extended flap portion is configured to allow the airbag cushion to deploy from the airbag housing in at least two stages, wherein, in a first stage of the at least two stages, the extended flap portion is configured to expand to allow the inflatable portion of the airbag cushion to partially deploy, and wherein, in a second stage of the at least two stages, the airbag cushion is configured to contact the extended flap portion and to reduce a punch-out force delivered by the airbag cushion during deployment prior to severing the weakened portion.

13. The airbag cushion assembly of claim 11, wherein the extended flap portion comprises a folded portion comprising a plurality of layers of the extended flap portion such that the inflatable portion of the airbag cushion can partially expand into the expanded portion after the folded portion has unfolded to define the expanded portion.

14. The airbag cushion assembly of claim 13, wherein the folded portion is defined by an accordion fold.

15. The airbag cushion assembly of claim 13, wherein the weakened portion is formed in at least one of the layers of the folded portion.

16. The airbag cushion assembly of claim 15, wherein the weakened portion is positioned underneath a top layer of the folded portion.

17. The airbag cushion assembly of claim 16, wherein the weakened portion comprises a tear seam.

18. An airbag cushion assembly, comprising:
an airbag housing comprising a bottom end and a top end opposite from the bottom end; and
an airbag cushion positioned within the airbag housing, wherein the airbag cushion is configured to deploy from the top end of the airbag housing, and wherein the airbag cushion comprises:
an inflatable portion; and
an extended flap portion extending from the inflatable portion as an integral part of the inflatable portion, wherein the extended flap portion is at least partially wrapped around the inflatable portion within the airbag housing, and wherein the extended flap portion comprises:
a folded portion comprising a plurality of layers of the extended flap portion, wherein the folded portion is positioned adjacent to the top end of the airbag housing, wherein the folded portion comprises a tear stitch configured to hold the folded portion in place prior to deployment of the airbag cushion, and wherein the folded portion is configured to unfold during deployment of the inflatable portion to define an expanded region of the extended flap portion; and
a tear seam formed in at least one of the layers of the folded portion, wherein the tear seam is configured to sever during deployment of the inflatable portion of the airbag cushion by contact with the inflatable portion after the inflatable portion has broken the tear stitch and the folded portion has unfolded to define the expanded region.

19. The airbag cushion assembly of claim 18, wherein the tear seam is positioned underneath a top layer of the folded portion.

20. The airbag cushion assembly of claim 18, wherein the extended flap portion is configured to redirect inflation of the airbag cushion during deployment to reduce injuries to an out-of-position vehicle occupant.
